(19) United States
(12) Patent Application Publication
(10) Pub. No.: US 2014/0348380 A1
(43) Pub. Date: Nov. 27, 2014

(54) METHOD AND APPRATUS FOR TRACKING OBJECTS

(71) Applicant: ELECTRONICS AND TELECOMMUNICATIONS RESEARCH INSTITUTE, Daejeon (KR)

(72) Inventors: Youngwoo YOON, Daejeon (KR); Woo han YUN, Daejeon (KR); Ho sub YOON, Daejeon (KR); Jae Yeon LEE, Daejeon (KR); Do-Hyung KIM, Daejeon (KR); Jae Hong KIM, Daejeon (KR); Jong-Hyun PARK, Daejeon (KR)

(73) Assignee: ELECTRONICS AND TELECOMMUNICATIONS RESEARCH INSTITUTE, Daejeon (KR)

(21) Appl. No.: 14/163,265

(22) Filed: Jan. 24, 2014

(30) Foreign Application Priority Data
May 24, 2013 (KR) 10-2013-0059117

(51) Int. Cl. G06K 9/00

(52) U.S. Cl. CPC G06K 9/00624
USPC 382/103

(57) ABSTRACT

A method for tracking an object in an object tracking apparatus includes receiving an image frame of an image; and detecting a target, a depth analogous obstacle and an appearance analogous obstacle; tracking the target, the depth analogous obstacle and the appearance analogous obstacle; when the detected target overlaps the depth analogous obstacle, comparing the variation of tracking score of the target with that of the depth analogous obstacle. Further, the method includes continuously tracking the target when the variation of tracking score of the target is below that of the depth analogous obstacle and processing a next frame when the variation of tracking score of the target is above that of the depth analogous obstacle; and re-detecting the target.

### CROSS-REFERENCE TO RELATED APPLICATION(S)

The present invention claims priority of Korean Patent Application No. 10-2013-0059117, filed on May 24, 2013, which is incorporated herein by reference.

### FIELD OF THE INVENTION

The present invention relates to a method and apparatus for tracking objects; and more particularly, to a method and apparatus for tracking objects and obstacles at the same time to accurately track a target.

### BACKGROUND OF THE INVENTION

In recent years, a research for an image-based object tracking technique is ongoing in diverse directions with the development of engineering technologies. In the case where a single object is tracked over an image, there exists representative method such as color-based tracking or appearance detection-based tracking.

A method for tracking an object over an image is carried by selecting color and type of the object. In connection with a method for tracking an object, Korean laid-open Patent publication 2011-0075250, which is laid-opened on Jul. 6, 2011, discloses an apparatus to provide an interface that enables the user to select a color of a target and a type of the target so that the user can select an object tracking mode.

However, in the method for tracking an object, the object tracking method based on appearance detection suffers from reduced tracking performance and low processing speed with respect to non-rigid materials. Further, the tracking accuracy of the object tracking performance is still low in the case where it tracks an object that is a non-ridge material such as a human body and has a large variation in appearance depending on a direction and pose.

### SUMMARY OF THE INVENTION

In view of the above, the present invention provides a method and apparatus for tracking an object that are robust against overlapping situation between a target and an obstacle that might interfere with the tracking of the target by simultaneously tracking the target and the obstacle and utilizing a color-based object tracking technique while subsidiarily utilizing an appearance detection-based technique. However, the technical subjects of the present invention are not limited to the aforementioned subjects, and there may be other technical subjects.

In accordance with a first aspect of the present invention, there is provided a method for tracking an object in an object tracking apparatus. The method includes receiving an image frame of an image captured by the image acquisition apparatus; detecting a target, a depth analogous obstacle with a similar depth to the target and an appearance analogous obstacle with a similar appearance to the target from the image frame; tracking the target, the depth analogous obstacle and the appearance analogous obstacle that are detected; when the detected target overlaps the depth analogous obstacle, comparing the variation of tracking score of the target with that of the depth analogous obstacle; and continuously tracking the target when the variation of tracking score of the target is below that of the depth analogous obstacle and processing a next frame when the variation of tracking score of the target is above that of the depth analogous obstacle; re-detecting the target.

In accordance with a second aspect of the present invention, there is provided an apparatus for tracking an object. The apparatus includes an input unit configured to receive an image frame of an image captured by an image acquisition apparatus; a detection unit configured to detect a target, a depth analogous obstacle with a similar depth to the target, and an appearance analogous obstacle with a similar appearance to the target from the image frame; a tracking unit configured to track the target, the depth analogous obstacle and the appearance analogous obstacle that are detected; a comparison unit configured to compare the variation of tracking score of the target with that of the depth analogous obstacle when the detected target overlaps the depth analogous obstacle; and an overlap analysis unit configured to continuously track the target when the variation of tracking score of the target is below that of the depth analogous obstacle and progressing to a next frame when the variation of tracking score of the target is above that of the depth analogous obstacle.

In accordance with any one of solutions to the subject described above, it is possible to reduce the drift phenomenon that might be occurred in tracking the target owing to the depth analogous obstacle and the appearance analogous obstacle.

### BRIEF DESCRIPTION OF THE DRAWINGS

The above and other objects and features of the present invention will become apparent from the following description of the embodiments given in conjunction with the accompanying drawings, in which:

FIG. 1 is a schematic configuration diagram illustrating an object tracking system in accordance with an embodiment of the present invention;

FIG. 2 is a block diagram of the object tracking apparatus shown in FIG. 1.

FIGS. 3A to 3K are views illustrating examples based on a tracking process to explain the operation concept of the an object tracking apparatus shown in FIG. 1;

FIG. 4 is a flow chart illustrating a process being controlled by the object tracking apparatus shown in FIG. 1; and

FIG. 5 is a flow diagram illustrating an object tracking method in accordance with an embodiment of the present invention.

### DETAILED DESCRIPTION OF THE EMBODIMENTS

Throughout the specification and the claims, when an element is described as being “connected” to another element, this implies that the elements may be directly connected together or the elements may be connected through one or more intervening elements. Furthermore, when an element is described as “including” one or more elements, this does not exclude additional, unspecified elements, nor does it preclude the presence or addition of one or more other features, integers, steps, operations, elements, components and/or groups thereof.

Hereinafter, embodiments of the present invention will be described in detail with reference to the accompanying drawings which form a part hereof.

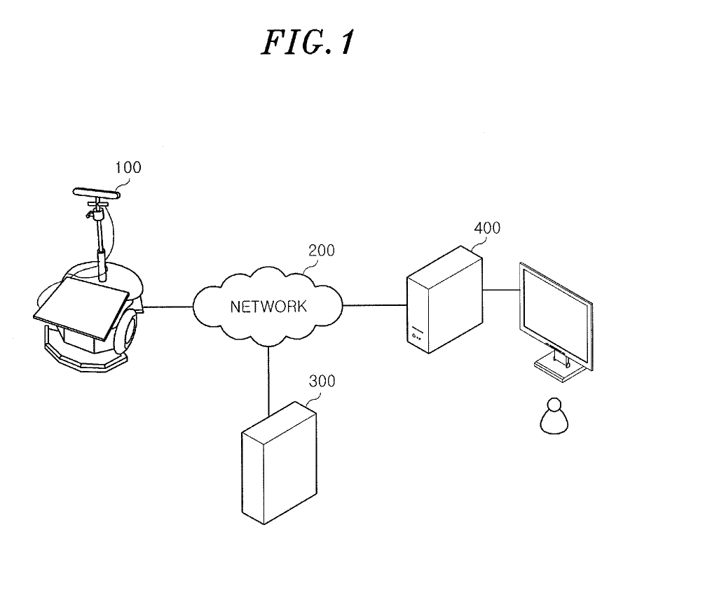

FIG. 1 is a schematic configuration diagram illustrating an object tracking system in accordance with an embodiment of the present invention. Referring to FIG. 1, an object tracking system 1 includes an image acquisition apparatus 100, an object tracking apparatus 300 and an output apparatus 400. However, it should be understood that the object tracking system 1 is merely an example and the present invention is not construed to be limited to FIG. 1.

The respective components of FIG. 1 are typically connected through a network 200. For example, as shown in FIG. 1, the image acquisition apparatus 100 and the object tracking apparatus 300 are connected via the network 200, and the object tracking apparatus 300 and the output apparatus 400 are connected via the network 200. Here, the object tracking apparatus 300 and the output apparatus 400 may be integrated in one unit. For example, the function of the output apparatus the output apparatus 400 may be incorporated in the object tracking apparatus 300. In addition, the image acquisition apparatus 100 is connected to the output apparatus 400 through the object tracking apparatus 300 via the network 200. It is understood that the image acquisition apparatus 100, the object tracking apparatus 300 and the output apparatus 400 are not limited to those shown in FIG. 1.

The image acquisition apparatus 100 may be provided with a RGB sensor and a depth sensor. The image acquisition apparatus 100 may have a wired or wirelessly connection with the object tracking apparatus 300 and may include a moving means which moves to track an object. Further, the image acquisition apparatus 100 may include a self-tilting ability and a self-left/right moving ability. The image acquisition apparatus 100 may be an apparatus to output RGB and depth images. Also, the image acquisition apparatus 100 may be an apparatus capable of moving along the object which is tracked by the object tracking apparatus 300. For example, the image acquisition apparatus 100 may be implemented by Kinect available from Microsoft Corporation or xTion available from ASUSTeK Computer Inc.

The object tracking apparatus 300 may be an apparatus to track an obstacle of which depth is similar to the target and an obstacle of which appearance is similar to the target using a RGB image and depth image from the image acquisition apparatus 100 at the same time. Thus, the object tracking apparatus 300 can simultaneously track the target and obstacles to increase tracking performance. In order to track both of the target and the obstacles, the object tracking apparatus 300 may include, for example, a Single tracker or a color-based MeanShift tracker. Further, the object tracking apparatus 300 may produce a top-view image using the depth image which is used to distinguish the target from an obstacle having a depth similar to that of the target. Here, the object tracking apparatus 300 may employ a target detector in order to distinguish the target from the obstacle having a similar appearance to the target. Further, the object tracking apparatus 300 may distinguish between the target and the obstacles in real time and enables the output apparatus 400 to separately display the target separate and the obstacles. In this regard, the object tracking apparatus 300 may be implemented by a computing device capable of accessing a server or terminal at a remote location through the network 200. Here, the computing device may include, for example, a notebook computer, desktop computer, laptop computer or the like having a web browser mounted therein. Also, the object tracking apparatus 300 may be implemented by a handheld-based wireless communication device that ensures portability and mobility, for example, which may include any kind of handheld-based wireless communication device such as a handset for PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), or Wibro (Wireless Broadband Internet), or smartphone, smart pad, Tablet PC, or the like.

The output apparatus 400 may separately display the target and obstacles that are tracked by the object tracking apparatus 300 on an image frame acquired by the image acquisition apparatus 100. Such a function of the output apparatus 400 may be implemented by one of several functions executed by the object tracking apparatus 300, and the output apparatus 400 may separately display the objects that are tracked in real time based on data received from the object tracking apparatus 300. This output apparatus 400 may be implemented by a computing device capable of accessing a server or terminal at a remote location through the network 200. Here, the computing device may include, for example, a notebook computer, desktop computer, laptop computer or the like having a web browser mounted thereon. In addition, the object tracking apparatus 300 may be implemented by a handheld-based wireless communication device that ensures portability and mobility, for example, which may include any kind of handheld-based wireless communication device such as a handset for PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet), smartphone, smart pad, Tablet PC, or the like.

The following is an example of an object tracking method of the embodiment of the present invention.

In recent years, a research for an image-based object tracking technique is underway in different directions. In the case of tracking a single object within an image, a color-based object tracing method or an appearance detection-based object tracking method exists.

The color-based object tracking method suffers from a drift phenomenon in which a tracker misidentifies a target with the other objects if the other objects having a similar color to the target is placed in the vicinity of the target and continues to track the other objects. The appearance detection-based object tracking method has a merit in that it is less sensitive to color, but has a demerit in that tracking performance decreases with respect to a flexible (non-rigid) object and processing speed is slow. In order to increase the performance of the appearance detection-based object tracking method, developed is a method utilizing in training obstacles that look similar to the target. However, the tracking may still fail in the case where it tracks an object that is a non-ridge material such as a human body and has a large variation in appearance depending on direction and pose.

Therefore, a method for tracking an object of the present invention employs a color-based object tracking technique while subsidiarity utilizing an appearance-based detection technique. As a result, since the obstacles that might interfere with the tracking of the target are tracked along with the target, it is possible to implement the embodiment of the present invention which is robust against overlapping situation between the target and the obstacles.

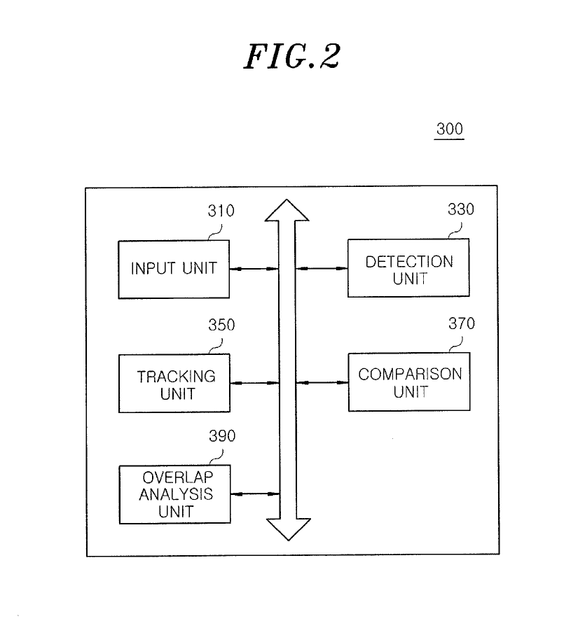

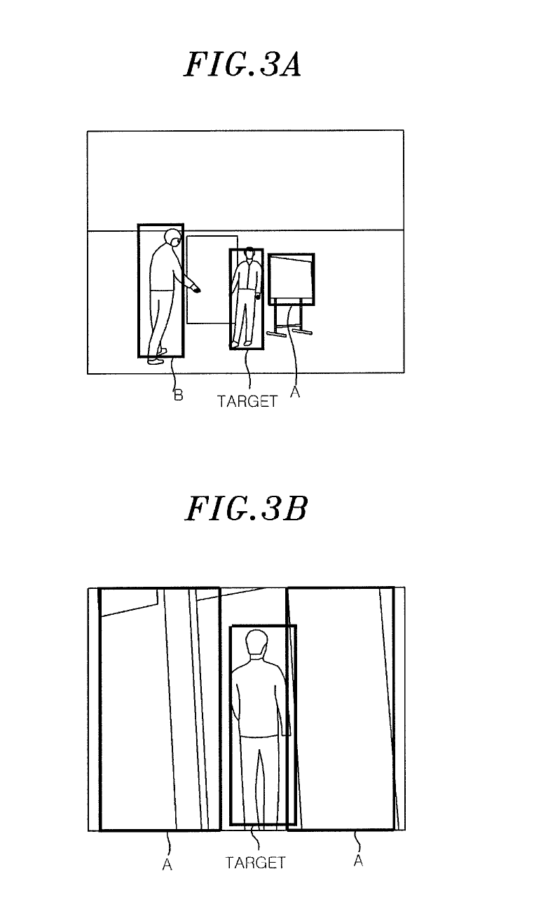

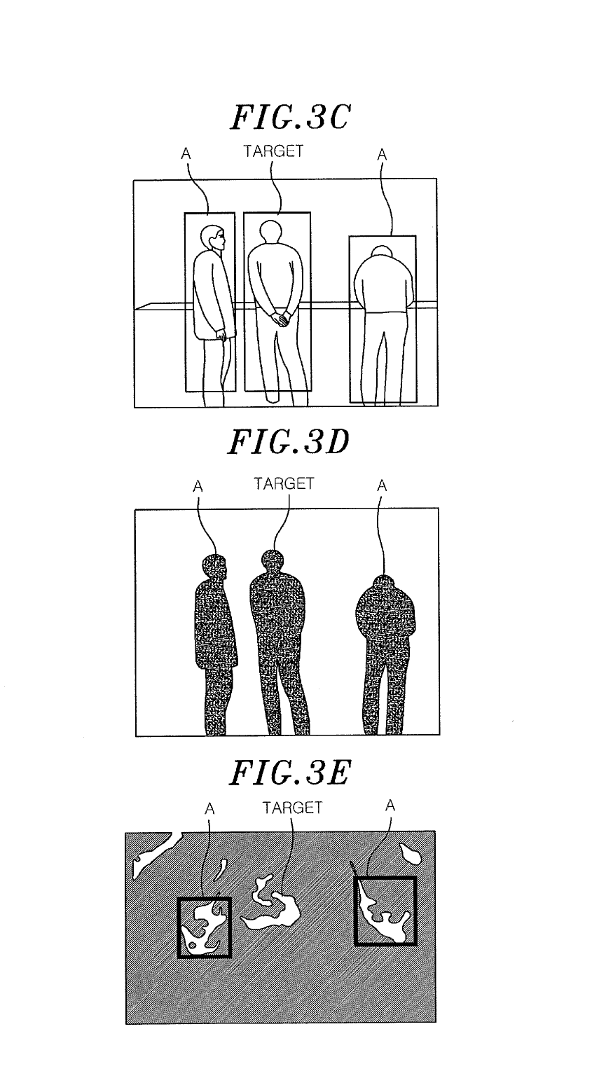

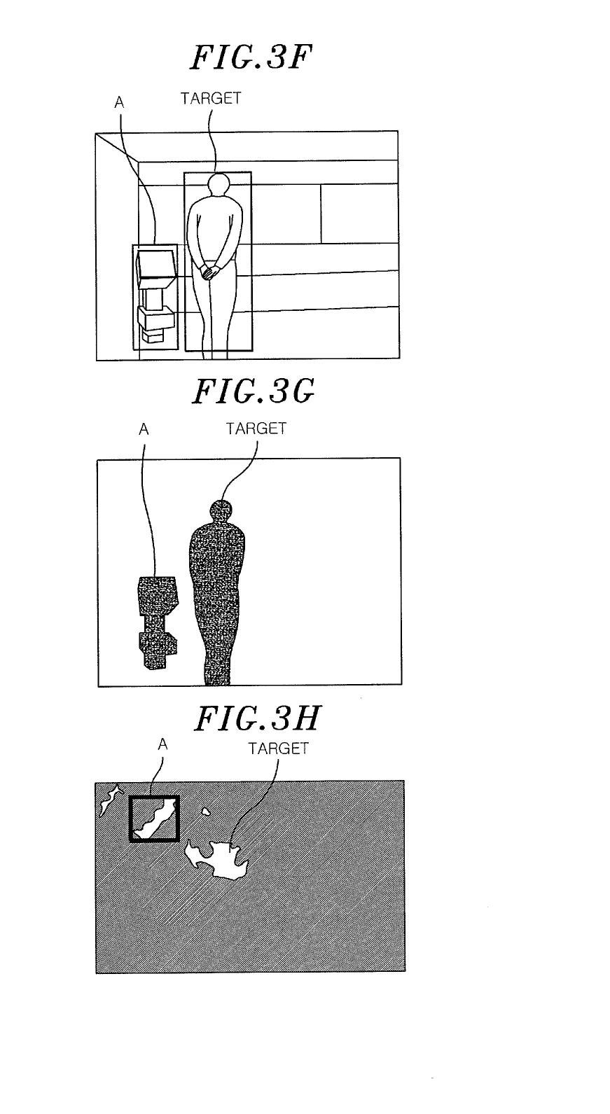

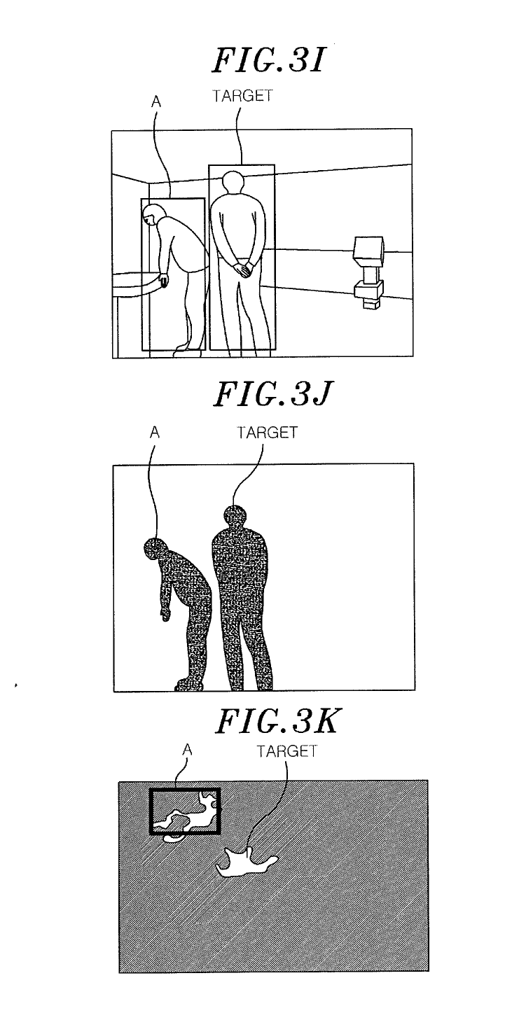

FIG. 2 is a block diagram of an object tracking apparatus shown in FIG. 1, and FIGS. 3A to 3k are views illustrating examples based on a tracking process to explain the operation concept of the object tracking apparatus shown in FIG. 1.

Referring to FIG. 2, the object tracking apparatus 300 in accordance with an embodiment of the present invention includes an input unit 310, a detection unit 330, a tracking unit 350, a comparison unit 370, and an overlap analysis unit 390.

The input unit 310 receives a sequence of image frames of an image captured by the image acquisition apparatus 100. That is, the input unit 310 may receive the image frames corresponding to a RGB image and a depth image.

The detection unit 330 detects a target, a depth analogous obstacle whose depth is similar to that of the target and an appearance analogous obstacle whose appearance is similar to that of the target. The deep analogous obstacle may be obtained by projecting a RGB image frame onto an X-Z plane, producing a top-view image using pixels within a predetermined depth range with reference to the depth of the target, performing a binarization on the top-view image, and removing blobs from the binarized top-view image. For example, the depth analogous obstacle may be an obstacle that is located near the user with reference to the depth. The target detector may malfunction in an environment where both of the target and the obstacles have the similar color and depth. Therefore, the object placed in a depth similar to the object is defined as the depth analogous obstacle.

To explain it with reference to FIGS. 3A and 3B, an object A in FIGS. 3A and 3B is an obstacle which is placed in a similar depth to the target. Thus, the object A can be defined as the appearance analogous obstacle. Similarly, an object B in FIG. 3A is also an obstacle with a similar appearance to the target and thus is defined as the appearance analogous obstacle. Further, FIGS. 3C, 3F and 3I show RGB images, FIGS. 3D, 3G and 3J show depth images, and FIGS. 3E, 3H and 3K show top-view images. Hereinafter, a description will be made on the definition of the depth and appearance analogous obstacles and how to extract them.

First, in order to detect the depth analogous obstacle, the detection unit 330 projects the depth images of FIGS. 3D, 3G and 3J onto a X-Z plane to transform it into a top-view image as shown in FIGS. 3E, 3H and 3K. In FIGS. 3C, 3F, 3I,3E, 3H and 3K, an X-axis means a horizontal axis of the image frame, a Y-axis means a vertical axis of the image frame, and a Z-axis means an axis representing a depth where the Z-axis may correspond to the values of respective pixels in the depth image of FIGS. 3D, 3G and 3J. When the depth image of FIGS. 3D, 3G and 3J are projected onto the X-Z plane by the detection unit 330, an image of which the overall scene is viewed from the top may be generated while Y-axis is eliminated. Here, the detection unit 330 may project all the pixels in the depth image onto the X-Z plane so that the pixel values of the projected image are proportioned to the number of pixels projected from the depth image. Accordingly, the projection of the depth image of FIGS. 3D, 3G and 3J onto the X-Z plane in the detection unit 330 may induce the top-view image of FIGS. 3E, 3H and 3K. In this case, the top-view image of FIGS. 3E, 3H and 3K are images which are binarized from the projected images.

Because the detection unit 330 needs to extract obstacle with a similar depth to the target, it specifies the range of depth (i.e., Z-axis) to produce the top-view image. For example, in the case where the depth of a target is 1000 at present, the detection unit 330 may project the pixels within the depth of 800 to 1200 to produce the top-view image. The detection unit 330 may then perform the binarization on the top-view image and extract connected blobs by applying the connection area analysis to the top-view image. After that, too large or small blobs are removed with the exception of the target, thereby detecting the depth analogous obstacle. Further, it is necessary to transform the depth analogous obstacle detected in the top-view image so that the depth analogous obstacle can be represented in the coordinate system of the RGB images of FIGS. 3C, 3F and 3I or depth images of FIGS. 3D, 3G and 3J. That is, since the mean depth of the detected depth analogous obstacle is known, the depth analogous obstacle may be extracted by leaving only pixels within a range of (the mean depth±a certain depth) from the depth images of FIGS. 3D, 3G and 3J. The detection unit 330 may finally detect the depth analogous obstacle in the coordinate system of FIGS. 3C, 3F and 3I or FIGS. 3D, 3G and 3J by detecting boundary areas of foreground parts in the binary images.

Secondly, the appearance analogous obstacle may be an object having a similar appearance to the target. Further, in the case where the target is tracked by the object tracker, the appearance analogous obstacle may be set by designating remaining objects with the exception of the target from the tracking result obtained by running the object tracker as the appearance analogous obstacle. In this case, although the user may arbitrarily designate the location of the target at the beginning of the tracking by the target tracking apparatus 300, if the target disappears and then appears during the operation of the detection unit 330, the object tracker should be used. The object tracker may be an appearance-based target detector. However, the appearance-based target detector may be more likely to detect incorrectly the object that looks similar to the target. For example, in the case where the target is a person and the other persons are standing next to the target, the appearance-based target detector may malfunction. Thus, the embodiment of the present invention may be designed to manage the appearance analogous obstacle in order to prevent the malfunction. Accordingly, the detection unit 330 may designate a remaining object with the exception of the target from the tracking result of the object tracker as the appearance analogous obstacle. For example, because only one target is tracked in one image frame, it may be considered that, in the case where there are two detected objects, the remainders, except the target in the image frame, are incorrectly detected. Therefore, the detection unit 330 may designate the remainders as the appearance analogous obstacle.

Returning to FIG. 2 again, the tracking unit 350 tracks the target, the depth analogous obstacle and the appearance analogous obstacle that are detected by the detection unit 330. That is, the depth analogous obstacle and the appearance analogous obstacle may be continuously tracked and managed similarly to the target. The depth analogous obstacle may be used to modify a color model of the object tracker in order to increase the color distinction ability between the target and the depth analogous obstacle by performing the histogram normalization process using the following Equation 1 when modeling the color of the target.

q=q/q₀ [EQUATION 1]

where q and q₀ at a right term denote a color histogram of the target and a color histogram of the depth analogous obstacle, respectively, and q at a left term denotes a updated color histogram. In other words, the likelihood that the target detector will suffer from the drift phenomenon can be decreased by dividing the color of the depth analogous obstacle by which the object tracker is more likely to drift. The term of drift means that the object tracker incorrectly tracks the other targets or obstacles other than the target.

In addition, in the case where the target overlaps the depth analogous obstacle, the following Equation 2 is used to determine which one of the target and the depth analogous obstacle is in front of another.

stdev({P₁ⁱ}_{i=t-k, . . . ,t})area(Obj₁)<stdev({P₂ⁱ}_{i=t-k, . . . ,t})area(Obj₂) [EQUATION 2]

where stdev means a standard deviation, Obj₁ means a first target, area(Obj₁) means an area size of a first target, and P₁ⁱ means a tracking score of the first object acquired by the object tracker in an i-th image frame. Further, Obj₂ means a second target, area(Obj₂) means an area size of the second target, P₂ⁱ means a tracking score of the second object acquired by the object tracker in the i-th image frame, t represents an index of a current image frame, and k is a setting of the user. In the Equation 2, therefore, the left term is defined as a variation in the tracking score with respect to the first target and the right term is defined as a variation in the tracking score with respect to the second target.

The tracking unit 350 continues the object tracking when it is determined that the target is in front of the others. However, in the case where the target is in behind of the others which may not catch the target, it is determined that the target is lost. Thus, the tracking unit 350 compares the tracking scores of the depth analogous obstacle and the target objects when they overlap each other to determine which object is in front of another. The tracking score, which is the output value from the object tracker, is a measure which tells how accurate the result of the current tracking is. In the overlapped situation, the object existing in front of another has a low variation of the tracking score, but the object that exists in behind another and overlaps another has an increased variation of the tracking score. Therefore, the tracking unit 350 determines which object is in front of another using the aforementioned Equation 2. Referring to the Equation 2, when objects having different sizes overlap each other, a larger object has a relatively small overlapped area. Therefore, it is necessary to normalize the difference between the tracking scores by multiplying the area size of the objects. The area( ) function may yield the area size by which a relevant object occupies. In a condition of the Equation 2, a first object is selected as an object located in front of another, and a second object may be selected in the other case. If the target is occluded, it is determined that the tracking is interrupted due to the occlusion of the target. The tracking unit 350 then settles such an explicit occlusion so that the object tracker can be prevented from suffering the drift to track the other objects when the target is occluded.

The comparison unit 370 compares the variations in tracking score of the target and the depth analogous obstacle when the detected target overlaps the depth analogous obstacle.

The overlap analysis unit 390 allows continuing the tracking of the target when the variation in tracking score of the target is below that of the depth analogous obstacle. On the contrary, the overlap analysis unit 390 allows advancing a following image frame when the variation in tracking score of the target is above that of the depth analogous obstacle. In other words, when the variation in tracking score of the target is below that of the depth analogous obstacle, the overlap analysis unit 390 determines that the target exists in front of another since there is almost no change in the variation in tracking scores between them and allows continuing the tracking of the target. However, when the variation in tracking score of the target is above that of the depth analogous obstacle, it indicates a great change in the variation in tracking scores between them; therefore, the overlap analysis unit 390 determines that the target exists in behind of another and allowing progressing to a next image frame since there is no target.

Further, after progressing to the next image frame, the overlap analysis unit 390 re-detects the target and determines whether the re-detected target is the appearance analogous obstacle. As a result of the determination, the re-detected target is tracked when the re-detected target is not the appearance analogous obstacle while the appearance analogous obstacle is tracked when the re-detected target is the appearance analogous obstacle. In addition, if the overlap analysis unit 390 does not re-detect the target, it tracks all of the depth analogous obstacle and the appearance analogous obstacle. For example, the object tracker will begin the tracking process when the target is re-detected after being occluded with the appearance analogous obstacle, but it may incorrectly select the other objects with a similar appearance to the target during the re-detection of the target. In order to prevent such a situation, the overlap analysis unit 390 excludes the appearance analogous obstacle when re-detecting the target, thereby preventing the situation where any other object other than the target is incorrectly selected. In the embodiment of the present invention, the target tracker may be implemented by one of several functions of the tracking unit 350.

The object tracking method in accordance with an embodiment of the present invention may be applied to various applications using a RGB-depth camera. For example, it may be utilized in a field of CCTV security control application. The security control requires to track an object under consideration in real time using PZT cameras, which is able to continuously track the object or person under consideration in a situation where several persons and objects are co-exist based on a real-time operation and a capability of processing an overlap between a target and obstacle. Further, for example, the object tracking method may be applied to a human following robot. The human following robot may be utilized in an application of HRI (Human Robot Interaction) where the robot tracks a person who is the target and continuously follows the tracked person. For a human following technology, because the distance between a person of the target and a camera becomes closer and far repeatedly, the appearance of the person may be terribly changed. Therefore, fast and reliable performance based on color and depth in accordance with an embodiment of the present invention, may be suitably used to the implement of the human following robot. Further, for example, the object tracking method may be utilized to an object tracking for a person who is visually handicapped. The advent of wearable cameras such as a Google glass enables the development of a computer vision application. Therefore, when a person to be tracked is selected by a blind person, the object tracker may continue to track the selected person and give an audible or tactile feedback to inform the blind person of where the target is located.

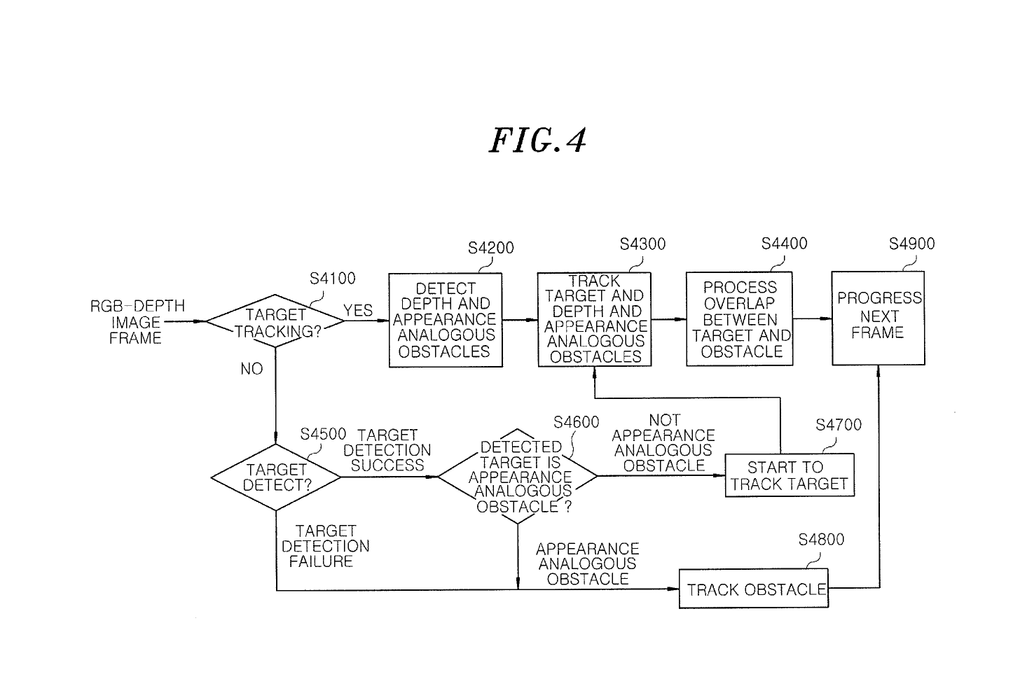

FIG. 4 is a flow chart illustrating a process being controlled by an object tracking apparatus shown in FIG. 1. Following is an example of a control process in accordance with an embodiment of the present invention but is not construed to be limited. It should be understood by those skilled in the art that the control process shown in FIG. 4 may be modified in accordance with various embodiments described earlier.

Referring to FIG. 4, upon receiving a RGB-depth frame, the object tracking apparatus checks whether the target is being tracked in operation 54100. When it is checked that the target is being tracked, the depth analogous obstacle A and the appearance analogous obstacle B are detected in operation S4200, and the target, the depth analogous obstacle A and the appearance analogous obstacle B are tracked in operation S4300. When the overlap between the target and the depth analogous obstacle A occurs during the tracking, an overlap process is performed in operation 54400 and then the control process goes to block S4900 for the processing of a next frame.

Meanwhile, when the target is not being tracked by the object tracking apparatus, it is determined whether the target is detected in operation 54500. When it is determined that the target is detected, the control process advances to block 54600 where it is determined whether or not the detected target is the appearance analogous obstacle B. When it is determined that the detected target is not the appearance analogous obstacle B, the target is tracked in operation 54700 and then the control process progresses to block S4300. However, when the detected target is the appearance analogous obstacle B, the appearance analogous obstacle B is tracked in operation 54800 and the control process goes to block S4900. Meanwhile, when the target is not detected in operation 54500, it indicates that the target does not detected and thus the control process advances to block 54800 to track the appearance analogous obstacle B and then progresses to block S4900.

Further details of the object tracking method shown in FIG. 4 will not be described below since they are similar or identical to the description made through FIG. 1 to FIG. 3 and can be easily inferred from the description.

The order of the above operations described in operations 54100 to S4900 is merely as an example and not limited thereto. In other words, the order of the operations described in operations 54100 to S4900 may be mutually exchanged, and some of these operations may be simultaneously executed or removed.

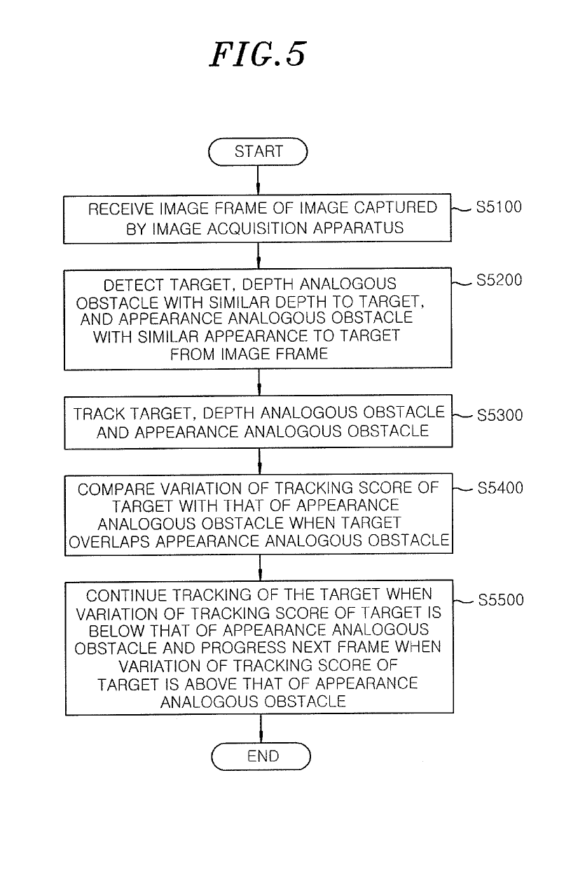

FIG. 5 is a flow diagram illustrating an object tracking method in accordance with an embodiment of the present invention.

First, the object tracking apparatus receives a sequence of an image frame of an image captured by the image acquisition apparatus in operation 55100.

Thereafter, the object tracking apparatus detects the target, the depth analogous obstacle with a similar depth to the target, and the appearance analogous obstacle with a similar appearance to the target from the image frame in operation S5200.

Next, the object tracking apparatus tracks the detected target, the depth analogous obstacle and the appearance analogous obstacle in operation S5300. If the detected target overlaps the appearance analogous obstacle, the object tracking apparatus compares the variation of tracking score of the target with that of the appearance analogous obstacle in operation S5400.

Finally, the object tracking apparatus continuously tracks the target when the variation of tracking score of the target is below that of the appearance analogous obstacle and progresses a next frame when the variation of tracking score of the target is above that of the appearance analogous obstacle in operation 55500.

The order of the above operations described in operations S5100 to 55500 is merely as an example and not limited thereto. In other words, the order of the operations described in operations S5100 to 55500 may be mutually exchanged, and some of these operations may be simultaneously executed or removed.

Further details of the object tracking method shown in FIG. 5 will not be described below since they are similar or identical to the description made through FIGS. 1 to 4 and can be easily inferred from the description.

The object tracking method described in FIG. 5 may be implemented in the form of recording media including instructions executable by a computer, such as applications or program modules that are executed by a computer. The computer readable media may be any available media that can be accessed by a computer and may include volatile and nonvolatile media, and removable and non-removable media. Further, the computer readable media may include any computer storage media and communication media. The computer storage media may include any volatile and nonvolatile media and removable and non-removable storage media that are implemented in any methods or technologies for the storage of information such as data and computer-readable instructions, data structures, program modules, or other data. The communication media may include a transport mechanism or any information delivery media for transmitting computer readable instructions, data structures, program modules or other data of modulated data signal such as carrier waves.

Description of the present invention as described above are intended for illustrative purposes, and it will be understood to those having ordinary skill in the art that this invention can be easily modified into other specific forms without changing the technical idea and the essential characteristics of the present invention. Accordingly, it should be understood that the embodiments described above are exemplary in all respects and not limited thereto. For example, respective components described to be one body may be implemented separately from one another, and likewise components described separately from one another may be implemented in an integrated type.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for tracking an object in an object tracking apparatus, the method comprising:
receiving an image frame of an image captured by the image acquisition apparatus;
detecting a target, a depth analogous obstacle with a similar depth to the target and an appearance analogous obstacle with a similar appearance to the target from the image frame;
tracking the target, the depth analogous obstacle and the appearance analogous obstacle that are detected;
when the detected target overlaps the depth analogous obstacle, comparing the variation of tracking score of the target with that of the depth analogous obstacle;
continuously tracking the target when the variation of tracking score of the target is below that of the depth analogous obstacle and processing a next frame when the variation of tracking score of the target is above that of the depth analogous obstacle; and
re-detecting the target.

2. The method of claim 1, wherein said re-detecting the target comprises:
checking whether the re-detected target is the appearance analogous obstacle; and
tracking the re-detected target when the re-detected target is not the appearance analogous obstacle and tracking the appearance analogous obstacle when the re-detected target is the appearance analogous obstacle.

3. The method of claim 2, further comprising:
when the target is not re-detected, tracking both of the depth analogous obstacle and the appearance analogous obstacle.

4. The method of claim 1, wherein the depth analogous obstacle is set by performing:
projecting the image frame onto an X-Z plane;
producing a top-view image based on a predetermined range of pixels with reference to the depth of the target; and
performing an binarization on the produced top-view image and removing blobs from the binarized image.

5. The method of claim 4, wherein an X-axis represents a horizontal axis of the image frame, a Y-axis represents a vertical axis of the image frame and Z-axis represents the depth of the target.

6. The method of claim 1, wherein the appearance analogous obstacle is set by designating remaining objects with the exception of the target from the tracking result obtained by running an object tracker as the appearance analogous obstacle.

7. The method of claim 1, wherein the depth analogous obstacle is used to modify a color model of an object tracker in order to increase the color distinction ability between the target and the depth analogous obstacle by performing the histogram normalization process such as the following Equation when modeling the color of the target.
q=q/q₀
where q and q₀ at a right term denote a color histogram of the target and a color histogram of the depth analogous obstacle, respectively, and q at a left term denotes a updated color histogram.

8. The method of claim 1, wherein said comparing the variation of tracking score of the target comprises, when the detected target overlaps the appearance analogous obstacle, determining which one of the target and the depth analogous obstacle is in front of another using the following Equation,
stdev({P₁ⁱ}_{i=t-k, . . . ,t})area(Obj₁)<stdev({P₂ⁱ}_{i=t-k, . . . ,t})area(Obj₂)
where stdev means a standard deviation, Obj₁ means a first target, area(Obj₁) means an area size of a first target, P₁ⁱ means a tracking score of the first object acquired by the object tracker in an i-th image frame, Obj₂ means a second target, area(Obj₂) means an area size of the second target, P₂ⁱ means a tracking score of the second object acquired by the object tracker in the i-th image frame, t represents an index of a current image frame, and k is a setting of the user.

9. The method of claim 1, wherein the image acquisition apparatus comprises a RGB camera and the RGB camera produces a RGB image and a depth image.

10. An apparatus for tracking an object, the apparatus comprising:
an input unit configured to receive an image frame of an image captured by an image acquisition apparatus;
a detection unit configured to detect a target, a depth analogous obstacle with a similar depth to the target, and an appearance analogous obstacle with a similar appearance to the target from the image frame;
a tracking unit configured to track the target, the depth analogous obstacle and the appearance analogous obstacle that are detected;
a comparison unit configured to compare the variation of tracking score of the target with that of the depth analogous obstacle when the detected target overlaps the depth analogous obstacle; and
an overlap analysis unit configured to continuously track the target when the variation of tracking score of the target is below that of the depth analogous obstacle and progressing to a next frame when the variation of tracking score of the target is above that of the depth analogous obstacle.

11. The apparatus of claim 10, wherein the overlap analysis unit is further configured to:
re-detect the target;
check whether the re-detected target is the appearance analogous obstacle; and
track the re-detected target when the re-detected target is not the appearance analogous obstacle and track the appearance analogous obstacle when the re-detected target is the appearance analogous obstacle.

12. The apparatus of claim 10, wherein the overlap analysis unit is further configured to track both of the depth analogous obstacle and the appearance analogous obstacle when the target is not re-detected.

13. The apparatus of claim 10, wherein the image acquisition apparatus comprises a RGB camera and the RGB camera includes a RGB sensor and a depth sensor.
